(19) United States
(12) Patent Application Publication
(10) Pub. No.: US 2015/0355942 A1
(43) Pub. Date: Dec. 10, 2015

(54) ENERGY-EFFICIENT REAL-TIME TASK SCHEDULER

(71) Applicant: TEXAS INSTRUMENTS INCORPORATED, Dallas, TX (US)

(72) Inventors: Alexei COLIN, Pittsburgh, PA (US); Ragunathan RAJKUMAR, Pittsburgh, PA (US); Arvind Kandhalu RAGHU, Plano, TX (US); Ramanuja VEDANTHAM, Allen, TX (US); Xiaolin LU, Plano, TX (US)

(21) Appl. No.: 14/729,765

(22) Filed: Jun. 3, 2015

Related U.S. Application Data
(60) Provisional application No. 62/007,490, filed on Jun. 4, 2014.

(51) Int. Cl. G06F 9/48; G06F 1/32; G06F 9/50

(52) U.S. Cl. CPC G06F 9/4893; G06F 9/5094; G06F 1/329; G06F 1/3293

(57) ABSTRACT

An energy efficient task scheduler for use with a processor that provides multiple reduced energy use modes. In one embodiment, a system for executing tasks includes a processor and a task scheduler. The processor provides a plurality of different reduced energy use modes. The task scheduler is executable by the processor to schedule execution a plurality of sleep tasks. Each of the sleep tasks corresponds to a different one of the reduced energy use modes. The task scheduler is executable by the processor to execute each of the sleep tasks, and as part of the execution of the sleep task to: place the processor in the reduced energy use mode corresponding to the sleep task, and exit the corresponding reduced energy use mode at suspension of the sleep task.

### CROSS-REFERENCE TO RELATED APPLICATIONS

The present application claims priority to U.S. Provisional Patent Application No. 62/007,490, filed Jun. 4, 2014, titled “Energy-Efficient Scheduling Algorithm for Real-Time Tasks on Multi-Sleep-State Platforms,” which is hereby incorporated herein by reference in its entirety.

### BACKGROUND

In many embedded processor applications, energy consumption is a primary concern. For example, in some battery powered applications, the working the life of a device is tied to the life of a primary cell powering the device. Some embedded processor applications are also subject to timing restraints. That is, particular processing tasks must be completed within a predetermined interval to ensure proper operation. Reduction of energy consumption is often contrary to meeting fixed timing constraints, and simplistic power management mechanisms may compromise response in embedded processor applications.

### SUMMARY

An energy efficient task scheduler for use with a processor that provides multiple reduced energy use modes is disclosed herein. In one embodiment, a non-transitory computer-readable medium is encoded with instructions that when executed cause a processor to execute a plurality of sleep tasks, each of the sleep tasks corresponding to a different reduced energy use mode of the processor. While executing each of the sleep tasks, the instructions place the processor in the reduced energy use mode corresponding to the sleep task, and exit the corresponding reduced energy use mode at suspension of the sleep task.

In another embodiment, a system for executing tasks includes a processor and a task scheduler. The processor provides a plurality of different reduced energy use modes. The task scheduler is executable by the processor to schedule execution a plurality of sleep tasks. Each of the sleep tasks corresponds to a different one of the reduced energy use modes. The task scheduler is executable by the processor to execute each of the sleep tasks, and as part of the execution of the sleep task to: place the processor in the reduced energy use mode corresponding to the sleep task, and exit the corresponding reduced energy use mode at suspension of the sleep task.

In a further embodiment, a system for scheduling task execution includes a first processor and a schedulability analyzer that is executable by the first processor to: schedule execution a plurality of sleep tasks by a second processor. Each of the sleep tasks corresponds to a different one of a plurality of reduced energy use modes of the second processor. The schedulability analyzer is also executable by the first processor to schedule execution of a plurality of application tasks by the second processor. The schedulability analyzer is to assign each of the application tasks a lower priority than any of the sleep tasks.

### BRIEF DESCRIPTION OF THE DRAWINGS

For a detailed description of various examples, reference will now be made to the accompanying drawings in which:

FIG. 1 shows a block diagram for a sensor node that includes energy efficient real-time task scheduling in accordance with various embodiments;

FIGS. 2 and 3 shows a timing diagram of tasks executed based on energy efficient real-time task scheduling in accordance with various embodiments;

FIGS. 4A, 4B, and 5 show examples of dynamic sleep task scheduling as part of energy efficient real-time task scheduling in accordance with various embodiments;

FIG. 6 shows a flow diagram for a method for energy efficient real-time task scheduling in accordance with various embodiments; and

FIG. 7 shows a block diagram for a system for analyzing schedulability of a task set for execution using energy efficient real-time task scheduling in accordance with various embodiments.

### NOTATION AND NOMENCLATURE

Certain terms are used throughout the following description and claims to refer to particular system components. As one skilled in the art will appreciate a component may be referred to by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or an indirect connection via other devices and connections. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In conventional processing systems, various scheduling techniques are employed in an attempt to ensure that processing deadlines are met. Energy consumption may or may not be a principle concern of conventional scheduling techniques. Processors may provide operation in multiple power modes, where the energy consumed by the processor varies with each different power mode. For example, a processor may provide an active mode in which the processor is fully powered and clocked, an idle mode in which the processor is fully powered and not clocked, a sleep mode in which a clock synthesizer is disabled and only select peripherals are functional, a deep sleep mode in which clocks to the processor and peripherals are halted and voltage to the processor and peripherals is reduced, etc. Each of the above listed, or similar power modes, provided by a processor may offer successively lower energy consumption. Unfortunately, lower energy consumption generally corresponds to increased power mode activation/deactivation times which make task scheduling increasingly difficult. For this reason, conventional scheduling techniques may not employ the energy use modes of a processor that offer the greatest reduction in energy consumption. Conventional scheduling techniques are also generally incapable of applying multiple low power modes of a processor to optimize energy savings.

The task scheduling system disclosed herein can apply multiple reduced energy use modes offered by a processor while ensuring that execution deadlines are met. Accordingly, embodiments of the scheduling system disclosed herein can reduced overall processor energy use without degrading real-time performance.

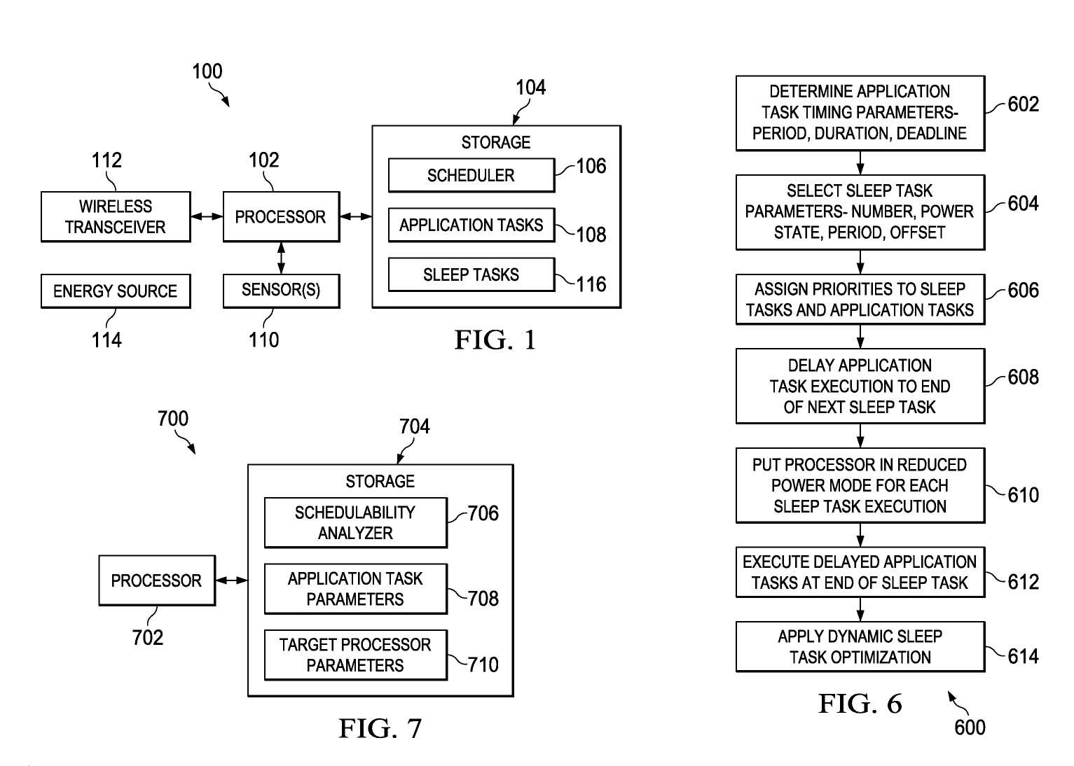

FIG. 1 shows a block diagram for a sensor node 100 that includes energy efficient real-time task scheduling in accordance with various embodiments. The sensor node 100 is a wireless device that senses conditions occurring in an environment in which the sensor node 100 operates, and transmits measurements and/or other information related to the environmental conditions to another device via a wireless sensor network. While the sensor node 100 is referenced herein to illustrate various embodiments of a task scheduling system, the scheduler disclosed herein has wide application and may be suitable for scheduling task execution in any system that includes a processor having multiple energy reduction modes.

The sensor node 100 includes a processor 102, storage 104, one or more sensor(s) 110, a wireless transceiver 112, and an energy source 114. The processor 102 may be a general-purpose microprocessor, a microcontroller, or other device capable of executing instructions retrieved from a computer-readable storage medium and suitable for use in a wireless sensor node. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The processor 102 includes multiple (e.g., 2 or more) reduced energy use modes, that when activated reduce the energy consumed by the processor 102 relative to the energy consumed by the processor while executing instructions in an active mode. For example, the processor 102 may provide an first reduced energy use mode in which the processor is fully powered and not clocked, a second reduced energy use mode in which a clock synthesizer is disabled and only select peripherals are functional, a third reduced energy use mode in which clocks to the processor and peripherals are halted and voltage to the processor and peripherals is reduced, etc. The second reduced energy use mode may provide reduced energy use relative to the first reduced energy use mode, and the third reduced energy use mode may provide reduced energy use relative to the second reduced energy use mode. The time required to transition between an active mode and the third reduced energy use mode may be greater than the time required to transition between an active mode and the second reduced energy use mode. The time required to transition between an active mode and the second reduced energy use mode may be greater than the time required to transition between an active mode and the first reduced energy use mode.

The energy source 114 provides energy to operate the processor 102, the storage 104, the sensors 110, the wireless transceiver 112, and other components of the wireless sensor node 100. The energy source 114 may include a battery, an energy harvesting system, and/or other power source suitable for use in the sensor node 100. Because the energy provided by the energy source 114 is limited, embodiments of the sensor node 100 may endeavor to reduce energy consumption, thereby reducing the cost of the sensor node 100 and/or increasing the operational life of the sensor node 100.

The sensor(s) 110 may include one or more transducers that detects conditions about the sensor node 100 and provides measurements of the conditions to the processor 102. For example, embodiments of the sensor(s) 110 may measure temperature, pressure, electrical current, humidity, or any other parameter associated with the operating environment of the sensor node 100.

The transceiver 112 converts signals between conducted and airwave forms to allow the sensor node 100 to communicate, via a wireless network, with other sensor nodes, a base station, and/or other devices.

The storage 104 may comprise non-volatile and/or volatile memory for storing instructions that are executed by the processor 102 and data that is processed by the processor 102. Examples of memory that may suitable for implementing the storage 104 include semiconductor memory (RAM), such as static RAM (SRAM), FLASH memory, electrically erasable programmable read-only memory (EEPROM), ferroelectric RAM (FRAM), and other storage technologies suitable for use in the sensor node 100.

The storage 104 contains scheduler 106, application tasks 108, and sleep tasks 116. The application tasks 108 include multiple sets of instructions (e.g., programs) that the processor 100 executes to provide the functionality of the sensor node 100. For example, the application tasks 108 may include a first task (i.e., set of instructions) that periodically monitors the sensors 110 to measure parameters of the environment in which the sensor node 100 operates, a second task to interact with the wireless transceiver 112 and/or provide services that allow the sensor node 100 to access a wireless network, and a third task to monitor/diagnose the health of the sensor node 100. In some embodiments, the application tasks 108 may include different and/or additional tasks. Each of the application tasks 108 may execute periodically (e.g., at a predetermined interval), require a known amount of time to execute, and require that execution be complete prior to a known deadline time (e.g., prior to the end of the period applicable to the task).

The sleep tasks 116 are executed to place the processor 102 in a reduced energy use mode. Each of the sleep tasks 116 corresponds to a different reduced energy use mode of the processor 116. Accordingly, a sleep task 116 may include instructions that are executed to cause the processor 102 to enter a reduced energy use mode and instructions that are executed on exit of a reduced energy use mode to prepare the processor 102 to execute the application tasks 108. The sleep tasks 116 may include at least two sleep tasks.

The scheduler 106 includes instructions that are executable by the processor to control when the application tasks 108 and the sleep tasks 116 are executed. The scheduler 106 can reduce the amount of energy used by the sensor node 100 by scheduling the application tasks 108 for execution in a manner that allows for use of two or more of the multiple reduced energy use modes of the processor 102, and maximizes the contiguous time intervals during which the processor 102 is in a reduced energy use mode.

To provide reduced energy use, the scheduler 106 executes the sleep tasks 116 in coordination with the application tasks 108. Each of the sleep tasks 116 corresponds to one of the reduced energy use modes of the processor 100. At initiation of execution of a sleep task, the processor 102 may enter the reduced energy use state associated with the sleep task, and at suspension of the sleep task the processor 100 may exit the reduced energy use state associated with the sleep task. The sleep tasks 116 may be executed in a sequence defined by the amount of energy use reduction provided by the reduced energy mode associated with sleep task. That is, a sleep task associated with a reduced energy use mode that provides higher energy reduction may be executed prior to a sleep task associated with a reduced energy use mode that provides lower energy reduction. Execution of each sleep task is offset in time from a previously executed sleep task by a time interval selected to allow for some execution of the application tasks 108. For example, the time interval between execution of two sleep tasks 116 may be the same as the period of the most frequently executed of the application tasks 108, one-half the period of the most frequently executed of the application tasks 108, etc.

As the application tasks 108 become ready to execute, the scheduler 106 may record the application tasks 108 as pending, and schedule the pending application tasks 108 for successive execution after a next executed sleep task has finished executing (i.e., after execution of the sleep task is suspended). By successively executing pending application tasks 108, the time during which the processor 102 is idle (i.e., not executing any of the application tasks 108) is increased, and in turn the time during which the processor 102 can be operated in a reduced energy use mode is increased and the energy use of the sensor node 100 is reduced. When the pending application tasks 108 have been executed, the scheduler 106 may place the processor 102 in a reduced energy use state selected based on the time remaining until the next execution of the application tasks 108.

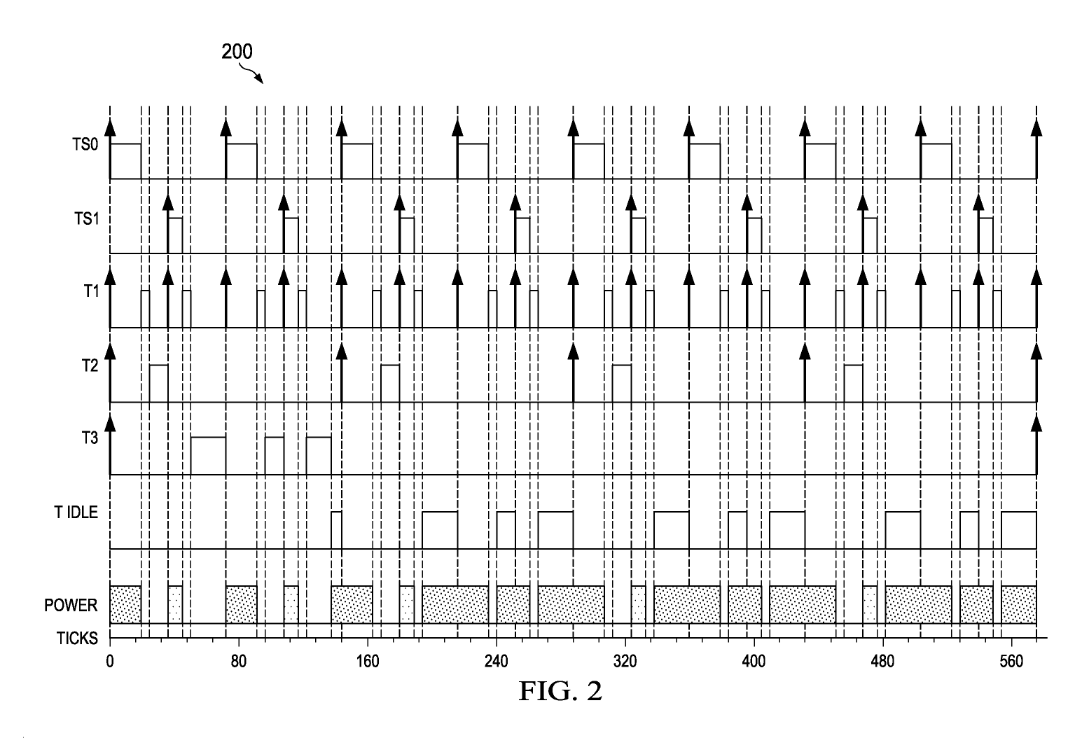

FIG. 2 shows a timing diagram 200 of task execution in the sensor node 100 with task scheduling provided by the scheduler 106. The timing diagram 200 shows two sleep tasks, TS0 and TS1, each of which corresponds to a different energy reduction mode of the processor 102. The energy reduction mode corresponding to TS0 provides more reduction in energy use than the energy reduction mode corresponding to TS1. Latency entering and/or exiting the energy reduction mode corresponding to TS0 is also greater than that of the energy reduction mode corresponding to TS1. The time offset separating TS0 and TS1 is equal to the period of task T1, and as there are two sleep tasks, the period of the sleep tasks is twice the period of task T1.

The application tasks executed are labeled T1, T2, and T3 in diagram 200. Task T1 is ready for execution every 36 milliseconds (ms) and requires 4 ms to execute. Task T2 is ready for execution every 144 ms and requires 12 ms to execute. Task T3 is ready for execution every 576 ms and requires 50 ms to execute. In diagram 200, for each task, the upward arrows indicate the time that the task becomes ready to execute, and the outlined time blocks indicate the time that the scheduler 106 allows the task to execute. The scheduler 106 allows a ready task to execute only after suspension of a sleep task subsequent to the tasking becoming ready to execute. After suspension of a sleep task, ready tasks are successively executed. The execution order of the successively executed tasks may be based on priority values assigned to the tasks. For example, application tasks may be assigned a priority such that a task having a shorter period has a higher priority than a task having a longer period, where a task having higher priority is scheduled to execute before a task having lower priority. The scheduler 106 assigns each of sleep tasks a higher priority than is assigned to any of the application tasks.

Diagram 200 also shows the time during which no task is ready to be executed (IDLE), and the times during which the processor 102 is in a reduced power mode. Heavier fill pattern indicates a reduced energy use mode that provides more reduction in energy use (i.e., uses less energy).

FIG. 3 shows a timing diagram 300 of task execution in the sensor node 100 with task scheduling provided by the scheduler 106. The timing diagram 300 shows two sleep tasks, TS2 and TS3, each of which corresponds to a different energy reduction mode of the processor 102. The energy reduction mode corresponding to TS2 provides more reduction in energy use than the energy reduction mode corresponding to TS3. Latency entering and/or exiting the energy reduction mode corresponding to TS2 is also greater than that of the energy reduction mode corresponding to TS3. The time offset separating TS0 and TS1 is equal to the period of task T4.

The application tasks executed are labeled T4, T5, and T6 in diagram 300. Task T4 is ready for execution every 36 milliseconds (ms) and requires 4 ms to execute. Task 2 is ready for execution every 60 ms and requires 12 ms to execute. Task 3 is ready for execution every 100 ms and requires 30 ms to execute. IDLE time and time spent in the reduced energy use states are also shown.

The scheduler 106 may also dynamically determine (i.e., determine at run-time) whether overall energy consumption can be optimized by skipping an upcoming sleep task and extending (by the length of the skipped sleep task) an idle interval that will occur sometime after the skipped sleep task. The scheduler 106 can evaluate:
(1) the total energy consumed by the processor 102 while in a scheduled sleep task and in the idle time following the scheduled sleep task through the subsequent sleep task; and
(2) the total energy consumed by the processor 102 if the scheduled sleep task is skipped and the length of the idle time following the scheduled sleep task is increased by the duration of scheduled sleep task.
   Based on these evaluations, the scheduler 106 can determine whether overall energy use can be reduced by skipping a sleep state.

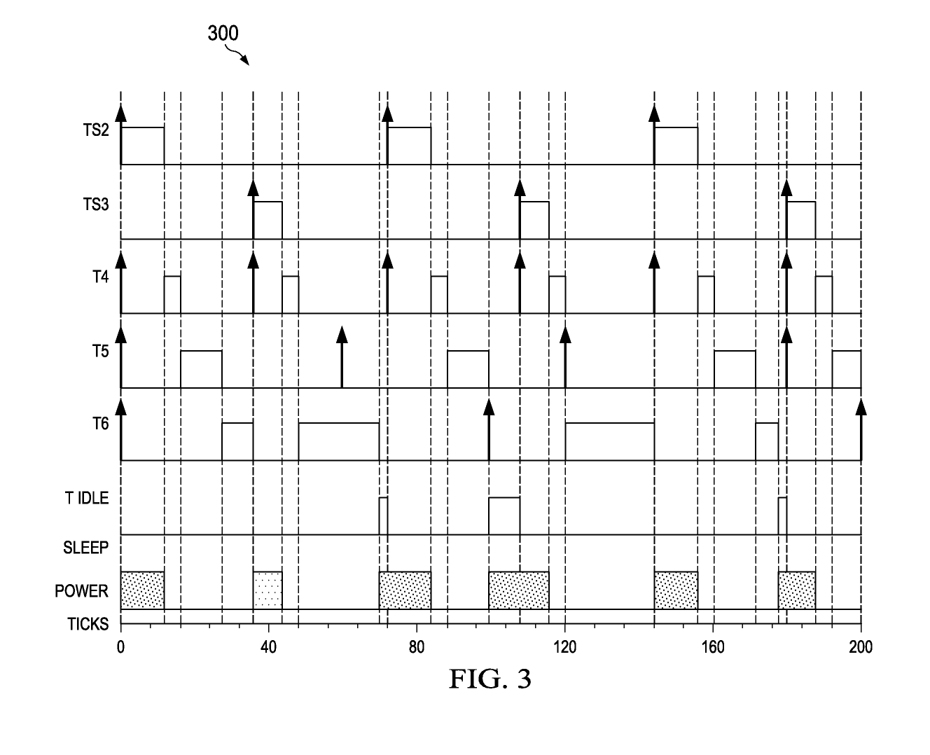

FIGS. 4A and 4B show an example of dynamic sleep task scheduling as part of energy efficient real-time task scheduling in accordance with various embodiments. In FIGS. 4A and 4B:

Cs1 is time scheduled for execution of sleep state 1;

Cs2 is time schedule for execution of sleep state 2;

p1 and p2 represent energy consumed in a reduced energy use mode;

p0 represents energy consumed in an idle state of the processor; and

pa represents energy consumption when the processor is active.

The scheduler 106 can apply the following computation to determine whether (1) provides lower energy consumption than (2):

t₂−t₁<(p₂−p₁)(p₀−p₁)Cs2

FIG. 4A shows energy use when the sleep state at Cs2 is not skipped. FIG. 4B shows energy use when the sleep state at CS2 is skipped and time equal to Cs2 is added to the idle time in reduced energy use mode p2 that follows the time scheduled for Cs2. In this example, the energy consumed when the sleep state at Cs2 is skipped is approximately the same as the energy consumed when the sleep state at Cs2 is not skipped.

FIG. 5 shows another example of dynamic sleep task scheduling as part of energy efficient real-time task scheduling in accordance with various embodiments. In the timing diagram 500, the application tasks and sleep tasks are as shown in FIG. 2, but dynamic sleep task scheduling is applied to skip some instances of sleep task TS1. By skipping some instances of sleep task TS1, longer idle intervals are created that allow use of energy reduction modes that provide more reduction in energy use than is available in diagram 200, where dynamic sleep task scheduling is not applied.

Various operations performed by the scheduler 106 may be described by the pseudo-code provided below.

```
procedure INIT
  for τᵢ ∈ Γ do
    rᵢ ← 0
    RELEASE(rᵢ)
// Schedule sleep task execution
procedure ATTIME(tⱼ ∈{kTₛ + φⱼ+ C_{s,j}:k∈ Γ}) for j = 1. . . s
  for τᵢ ∈ Γ do
    if t − C_{s,j} − rᵢ > T_{H} then
      RELEASE (rᵢ)
      rᵢ ← rᵢ +Tᵢ
// Schedule application task execution
procedure ATTIME(t ∈{kT_{H}:k∈ Γ})
  for τᵢ ∈ Γ do
    if t − rᵢ >T_{H} then
      RELEASE (rᵢ)
// Select reduced energy use mode to be applied during idle time
procedure ONIDLE (t)
  $r ← min \{ ⌈ \frac{t}{{T}_{H}} ⌉ , ⌈ \frac{t}{{T}_{s}} ⌉ + {C}_{s} \}$
  t_{I} ← t − r
  E ← {ωₗ ∈ Ω:eₗ ≦ t_{I}}
  ωₗ ← arg min_{ωl∈E} pₗ
  SLEEP (t_{I} − eₗ, ωₗ)
```

where:
Γ: set of all tasks;
Cᵢ: worst-case execution time (e.g. in cycles);
Tᵢ: period (inter-arrival time);
Dᵢ: deadline of task i;
τᵢ: task i;
ωₗ: reduced energy use mode l;
pₗ: power consumption of reduced energy use mode l;
Ω: set of reduced energy use modes;
eₗ: break-even time length for reduced energy use mode l;
E: break-even time;
C_{s,j}: cycles to enter reduced energy use mode j;
T_{s,j}: period of sleep task j;
T_{H}: harmonizing period (i.e., interval between sleep task executions); and
φᵢ: phase offset of task i.

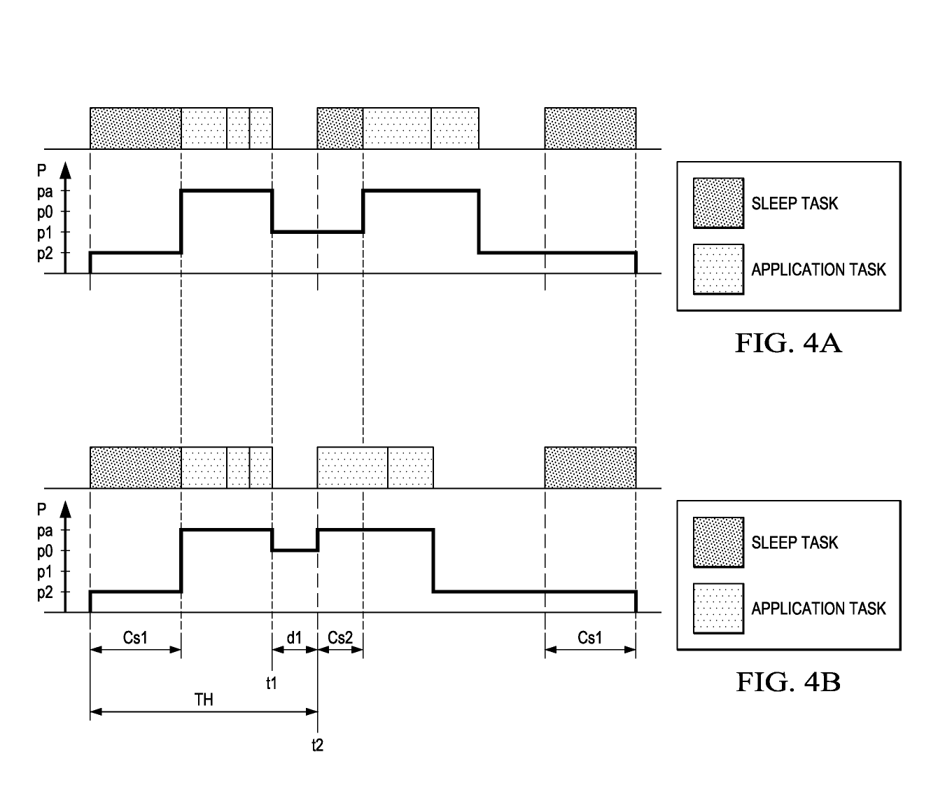

FIG. 6 shows a flow diagram for a method for energy efficient real-time task scheduling in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of FIG. 6, as well as other operations described herein, can be implemented as instructions stored in a computer readable medium (e.g., storage 104) and executed by one or more processors (e.g., processor 102).

In block 602, the parameters of the application tasks 108 to be executed by the processor 102 are determined. The parameters may include the period of each application task, the execution duration of each application task, a deadline for completing execution of each application task, etc.

In block 604, the parameters of the two or more sleep tasks 116 to be executed by the processor 102 are determined. The parameters may include the number of sleep tasks, the reduced energy use mode of the processor 102 to be applied during execution of each sleep task, the period of the sleep tasks, the offset between sleep tasks, etc. As explained herein, a different reduced energy use mode of the processor 102 will be applied during execution of each sleep task.

In block 606, priorities are assigned to each sleep task and each application tasks. Each sleep task may be assigned a higher priority than any of the application tasks. Priorities may be assigned to the application tasks in inverse relation to the period of each task (i.e., shorter period=higher priority).

In block 608, the processor 102 is executing the application tasks 108 and the sleep tasks 116. As each application task 108 becomes ready to execute, the application task's availability for execution is recorded, and execution of the task is delayed until execution of the next sleep task is complete.

In block 610, the processor 102 executes one of the sleep tasks 116. Any executing application task is preempted and the processor 102 is set to operate in the reduced energy use mode associated with the sleep task.

In block 612, execution of the sleep task is complete (i.e., the sleep task is suspended) and the application tasks that became ready to execute prior to or during execution of the sleep task are dispatched for execution. Pending application tasks are successively executed with higher priority application tasks executed before lower priority application tasks.

In block 614, execution of pending application tasks is complete. The processor 102 applies dynamic sleep task optimization to determine whether an upcoming sleep task should be skipped. The processor 102 may compute the amount of energy to be used if the next sleep task is executed as scheduled, and the amount of energy to be used if the next sleep task is skipped (i.e., pending application tasks are executed at the time scheduled for execution of the next sleep task). Accordingly, the processor may revise the sleep task schedule to skip execution of the next scheduled sleep task if such skipping will reduce energy consumption by, for example, allowing use of a more beneficial reduced energy use mode.

Based on the amount of time until the next application task execution, the processor 102 selects a reduced energy use mode and sets the processor 102 to operate in the selected mode until application tasks are to be executed.

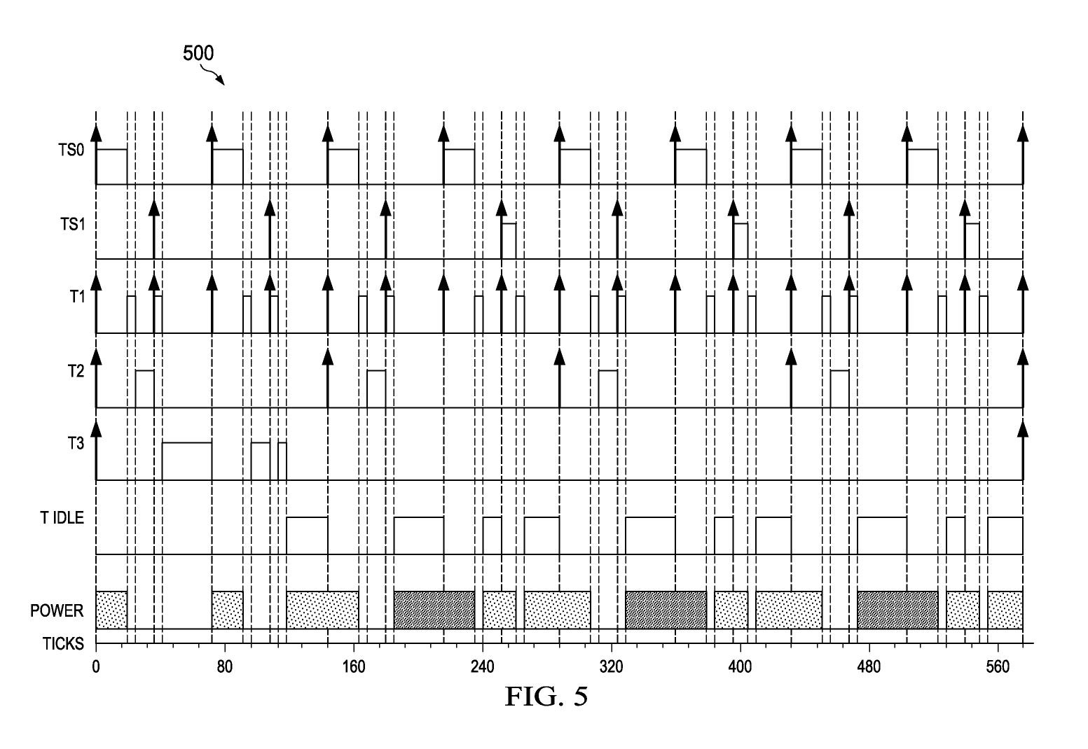

FIG. 7 shows a block diagram for a system 700 for analyzing schedulability of a task set for execution using energy efficient real-time task scheduling in accordance with various embodiments. The system 700 includes a processor 702 and storage 704. The processor 702 may be a general-purpose microprocessor, digital signal processor, a microcontroller or other device capable of executing instructions retrieved from a computer-readable storage medium. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

The storage 704 is a non-transitory computer-readable storage medium suitable for storing instructions executable by the processor 702, and for storing data for processing by the processor 102. The storage 204 may include volatile storage such as random access memory, non-volatile storage (e.g., a hard drive, an optical storage device (e.g., CD or DVD), FLASH storage, read-only-memory), or combinations thereof.

In some implementations, the system 700 may be embodied in a computer, such as a desktop computer, a workstation computer, rack mount computer, a notebook computer, or other form of computer known in the art. The system 700 may include various components that have omitted from FIG. 7 as a matter of clarity. For example, the system 700 may include a display device, a user input device, a network adapter, etc.

The storage 704 contains a schedulability analyzer 706, application task parameters 708, and target processor parameters 710. The target processor parameters 710 include information specifying various parameters of a target processor (e.g., the processor 102) on which a set of application tasks are to be executed. For example, the target processor parameters 710 may specify the reduced energy use modes provided by the target processor, energy consumed in each reduced energy use mode, time to enter and exit each reduced energy use mode, etc. The application task parameters 708 include information specifying various parameters of the application tasks to be executed on the target processor. For example, the application task parameters 708 may include the number of application tasks to be executed, the period of each application task, the execution duration of each application task on the target processor, a deadline for completing execution of each application task, etc.

The schedulability analyzer 706 determines whether the application tasks specified in the application task parameters 708 can be executed on the target processor using the energy efficient real-time task scheduler 106. In the system 700, schedulability for a first a task of the application tasks 108 may be computed as:

$$\frac{{C}_{1}}{{T}_{1}} + \frac{{S}_{1}}{{T}_{S}} \leq 1$$

where:
Cᵢ is the execution time of application task i;
Tᵢ is the period of application task i;
Tₛ is the period of the sleep tasks; and
Sᵢ is the duration of sleep task k.

Schedulability of other tasks of the application tasks 108 may be computed as:

$$∀ i \geq 2 : {\sum }_{j = 1}^{i} \frac{{C}_{j}}{{T}_{j}} + \frac{{T}_{s}}{{T}_{i}} + {\sum }_{k = 1}^{K} \frac{{S}_{k}}{{KT}_{s}} \leq i ( {2}^{1 / i} - 1 )$$

where:
K is the number of sleep tasks (i.e., the number of reduced energy use modes applied).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A non-transitory computer-readable medium encoded with instructions that when executed cause a processor to:
execute a plurality of sleep tasks, each of the sleep tasks corresponding to a different reduced energy use mode of the processor; and
while executing each of the sleep tasks, place the processor in the reduced energy use mode corresponding to the sleep task, and exit the corresponding reduced energy use mode at suspension of the sleep task.

2. The computer-readable medium of claim 1, further comprising instructions that when executed cause the processor to execute a plurality of application tasks while none of the sleep tasks is executing.

3. The computer-readable medium of claim 2, further comprising instructions that when executed cause the processor to coalesce execution of the application tasks to increase time during which the processor is in a reduced energy use mode.

4. The computer-readable medium of claim 1, further comprising instructions that when executed cause the processor to delay execution of the application tasks to increase time during which the processor is in a reduced energy use mode.

5. The computer-readable medium of claim 1, further comprising instructions that when executed cause the processor to assign higher priorities to the sleep tasks than a priority assigned to any application task.

6. The computer-readable medium of claim 1, further comprising instructions that when executed cause the processor to arrange the sleep tasks for execution in order of successively higher energy use by the processor.

7. The computer-readable medium of claim 1, further comprising instructions that when executed cause the processor to offset in time each of the sleep tasks from a preceding sleep task and a succeeding sleep task by an equal time interval.

8. The computer-readable medium of claim 1, further comprising instructions that when executed cause the processor to determine whether to shift time allocated to a given one of the sleep tasks to an idle interval scheduled to occur after the time allocated to the given one of the sleep tasks; wherein the determination of whether to shift the execution time is based on whether shifting of the execution time will reduce processor energy consumption relative to not shifting the execution time.

9. A system for executing tasks, comprising:
a processor that provides a plurality of different reduced energy use modes; and
a task scheduler that is executable by the processor to:
schedule execution a plurality of sleep tasks, each of the sleep tasks corresponding to a different one of the reduced energy use modes; and
execute each of the sleep tasks, and as part of the execution to:
place the processor in the reduced energy use mode corresponding to the sleep task, and
exit the corresponding reduced energy use mode at suspension of the sleep task.

10. The system of claim 9, wherein the task scheduler causes the processor to schedule a plurality of application tasks for execution while none of the sleep tasks is executing.

11. The system of claim 9, wherein the task scheduler causes the processor to coalesce execution of the application tasks to increase time during which the processor is in a reduced energy use mode.

12. The system of claim 9, wherein the task scheduler causes the processor to delay execution of the application tasks to increase time during which the processor is in a reduced energy use mode.

13. The system of claim 9, wherein the task scheduler causes the processor to execute each of the sleep tasks at a higher priority than any application task.

14. The system of claim 9, wherein the task scheduler causes the processor to arrange the sleep tasks for execution in order of successively higher energy use by the processor.

15. The system of claim 9, wherein the task scheduler causes the processor to offset, in time, each of the sleep tasks from a preceding sleep task and a succeeding sleep task by an equal time interval.

16. The system of claim 9, wherein the task scheduler causes the processor to determine whether to shift time allocated to a given one of the sleep tasks to an idle interval scheduled to occur after the time allocated to the given one of the sleep tasks; wherein the determination of whether to shift the execution time is based on whether shifting of the execution time will reduce processor energy consumption relative to not shifting the execution time.

17. A system for scheduling task execution, comprising:
a first processor;
a schedulability analyzer that is executable by the first processor to:
schedule execution a plurality of sleep tasks by a second processor, each of the sleep tasks corresponding to a different one of a plurality of reduced energy use modes of the second processor; and
schedule execution of a plurality of application tasks by the second processor, wherein the schedulability analyzer is to assign each of the application tasks a lower priority than any of the sleep tasks.

18. The system of claim 17, wherein the schedulability analyzer causes the first processor to arrange the plurality of application tasks to execute consecutively.

19. The system of claim 17, wherein the schedulability analyzer causes the first processor to schedule execution of the application tasks such that execution of each of the application tasks that is ready to execute before a given one of the sleep tasks is delayed until suspension of the given one of the sleep tasks.

20. The system of claim 17, wherein the schedulability analyzer causes the first processor to determine whether the application tasks are schedulable for execution by the second processor based on:
a duration of each of the sleep tasks;
a number of reduced energy use modes of the second processor that are applied to sleep tasks;
an execution period of each of the application tasks;
an execution duration of each of the application tasks; and
a time interval between the sleep tasks.
